(19) United States
(12) Patent Application Publication
(10) Pub. No.: US 2007/0201227 A1
(43) Pub. Date: Aug. 30, 2007

(54) Light cable accessory for an electronic device and methods of operating a lighted cable accessory for an electronic device

(76) Inventors: William O. Camp JR., Chapel Hill, NC (US); Hanqi Yang, Apex, NC (US); Shuang Guo, Cary, NC (US)

Correspondence Address: MYERS BIGEL SIBLEY & SAJOVEC, P.A., P.O. BOX 37428, RALEIGH, NC, 27627, US

(21) Appl. No.: 11/363,073

(22) Filed: Feb. 27, 2006

(51) Int. Cl. F21V 33/00

(52) U.S. Cl. 362/253

(57) ABSTRACT

An accessory for an electronic device includes a cable, such as an audio cable having first and second ends, and a plurality of light guides attached to the cable. The light guides have first ends proximate the first end of the cable and extend along a length of the cable. Respective ones of the plurality of light guides terminate at different points along the length of the cable. The accessory may further include an interface adapter coupled to the cable and the plurality of light guides and at least one light emitting device, and the light guides may be configured to receive light emitted by the at least one light emitting device.

### FIELD OF THE INVENTION

The present invention relates to portable electronic devices, and in particular to accessories for portable electronic devices.

### BACKGROUND

Accessories are commonly provided for portable electronic devices, such as mobile telephones. For example, a number of portable electronic devices, such as mobile telephones, portable radios and CD players, MP3 players, and even personal digital assistants (PDAs), include 2.5 mm audio jack connectors for connecting headphones that may be used, for example, to listen to music and/or to hear a remote party in a telephone call.

Some types of portable electronic devices, in particular mobile telephones, include system bus connectors, which may permit the attachment of more complex accessories to the devices, such as smart chargers, data interfaces, and other accessories.

For portable electronic devices that produce an audible output, lightweight earbuds (i.e., earphones that fit in the user's ear and are not connected to a common support frame that fits over the head) are commonly used instead of more bulky headphones. However, lightweight earbuds may still be connected to the portable electronic device by long cables.

Many users prefer to use lightweight wired earbuds instead of wireless solutions, such as Bluetooth wireless headsets, due to the relative expense of wireless devices and/or the difficulty of keeping such devices securely attached to the ear while engaging in physical activities.

The presence of an earphone wire may form part of an iconic stylistic image that may be desirable to a user of a portable electronic device. Users of portable electronic devices may desire to increase the visibility and/or importance of the earphone wire in the operation and/or overall stylistic image created by the device.

### SUMMARY

An accessory for an electronic device according to some embodiments of the invention includes an audio cable having first and second ends, and a plurality of light guides attached to the audio cable. The light guides have first ends proximate the first end of the audio cable and extend along a length of the audio cable. Respective ones of the plurality of light guides terminate at second ends at different points along the length of the audio cable.

The accessory may further include a transparent protective covering over the audio cable and the plurality of light guides. The audio cable may include at least one earphone at the second end thereof.

The accessory may further include an interface adapter coupled to the audio cable and the plurality of light guides. The interface adapter may include at least one light emitting device, and the light guides may be configured to receive light emitted by the at least one light emitting device.

The interface adapter may include an input terminal coupled to an anode of the at least one light emitting device and a ground terminal coupled to a cathode of the at least one light emitting device.

The interface adapter may include a decoder having a plurality of input lines and a plurality of output lines, and may further include a plurality of light emitting devices. Each of the plurality of light emitting devices may be coupled to a respective one of the plurality of output lines of the decoder and may be configured to be illuminated upon selection of a respective one of the plurality of output lines.

The interface adapter may include an audio input configured to receive an audio signal, and an interface circuit coupled between the audio input and the light emitting device(s) and configured to control the illumination of the light emitting device(s) based on the audio signal.

The interface circuit may include a filter configured to filter the audio signal. The filter may include an envelope detector circuit. The interface circuit may further include an amplifier configured to amplify the audio signal.

The accessory may further include a voltage source input configured to provide a voltage to the interface circuit, and a switch configured to switch the voltage source input to the interface circuit in response to a control signal.

The at least one light emitting device may include at least a first light emitting device configured to emit light having a first dominant wavelength and the plurality of light guides may include a first plurality of light guides. The interface adapter may further include at least a second light emitting device configured to emit light having a second dominant wavelength, different from the first dominant wavelength, and a second plurality of light guides having first ends proximate the first end of the audio cable and extending along a length of the audio cable. Respective ones of the second plurality of light guides may terminate at different points along the length of the audio cable. Respective ones of the second plurality of light guides may terminate at different points along the length of the audio cable than the first plurality of light guides.

Some embodiments of the invention provide an accessory for an electronic device including an interface adapter having a plurality of input terminals and configured to be attached to the electronic device, an audio cable having a first end coupled to the interface adapter and a second end distal from the interface adapter, and a plurality of light emission locations at different points along a length of the audio cable and configured to emit light in response to a control signal received by the interface adapter. The interface adapter may include at least one control input configured to receive the control signal.

The interface adapter may include at least one light emitting device and the audio cable may include a plurality of light guides configured to receive light emitted by the at least one light emitting device. The light guides may extend from the interface adapter to respective ones of the light emission locations.

The interface adapter may include an input terminal coupled to an anode of the at least one light emitting device and configured to receive the control signal and a ground terminal coupled to a cathode of the at least one light emitting device.

The interface adapter may include a decoder having a plurality of input lines and a plurality of output lines, and may further include a plurality of light emitting devices. Each of the plurality of light emitting devices may be coupled to a respective one of the plurality of output lines and may be configured to be illuminated upon selection of the respective one of the plurality of output lines. The audio cable may include a plurality of light guides configured to receive light emitted by the plurality of light emitting devices and may extend from the interface adapter to respective ones of the light emission locations.

The interface adapter may include an audio input configured to receive an audio signal, and an interface circuit coupled to the audio input and configured to control the emission of light at the light emission locations based on the audio signal. The interface circuit may include a filter configured to filter the audio signal. The filter may include an envelope detector circuit. The interface circuit may include an amplifier configured to amplify the audio signal.

The accessory may further include a voltage source input configured to provide a voltage to the interface circuit, and a switch configured to switch the voltage source input to the interface circuit in response to a control signal.

Some embodiments of the invention provide methods of operating an accessory for an electronic device, the accessory including a cable having a plurality of light emission locations along a length thereof and configured to emit light in response to a control signal received by the accessory. The methods include selectively illuminating the light emission locations in response to the control signal. The methods may include selectively illuminating the light emission locations in response to an audio signal transmitted on the accessory.

The electronic device may include a mobile telephone, and selectively illuminating the light emission locations may include selectively illuminating the light emission locations according to a selected pattern when a call is received at the mobile telephone. The selected pattern may be based on a caller identification associated with the received call.

Selectively illuminating the light emission locations may include selectively illuminating the light emission locations in synchronization with beats of a music program transmitted on the accessory.

Selectively illuminating the light emission locations may include selectively illuminating the light emission locations in a pattern that appears to move along the cable toward and/or away from the electronic device.

Selectively illuminating the light emission locations may include selectively illuminating the light emission locations based on a current state of the electronic device.

### DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic block diagram of a portable electronic device according to some embodiments of the invention;

FIG. 2 is a schematic view of a portable electronic device and an accessory therefor according to some embodiments of the invention;

FIG. 3 is a schematic cross section of an accessory cable according to some embodiments of the invention;

FIGS. 4-6 are schematic illustrations of interface adapters according to embodiments of the invention;

FIG. 7 is a schematic block diagram of an interface circuit according to some embodiments of the invention; and

FIG. 8 is a schematic circuit diagram of an envelope detection circuit suitable for use in some embodiments of the invention.

### DETAILED DESCRIPTION

The present invention now will be described more fully hereinafter with reference to the accompanying drawings, in which embodiments of the invention are shown. This invention should not be construed as limited to the embodiments set forth herein; rather, these embodiments are provided so that this disclosure will be thorough and complete, and will fully convey the scope of the invention to those skilled in the art. Like numbers refer to like elements throughout. Furthermore, the various features and regions illustrated in the figures are illustrated schematically. Accordingly, the present invention is not limited to the relative size and spacing illustrated in the accompanying figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

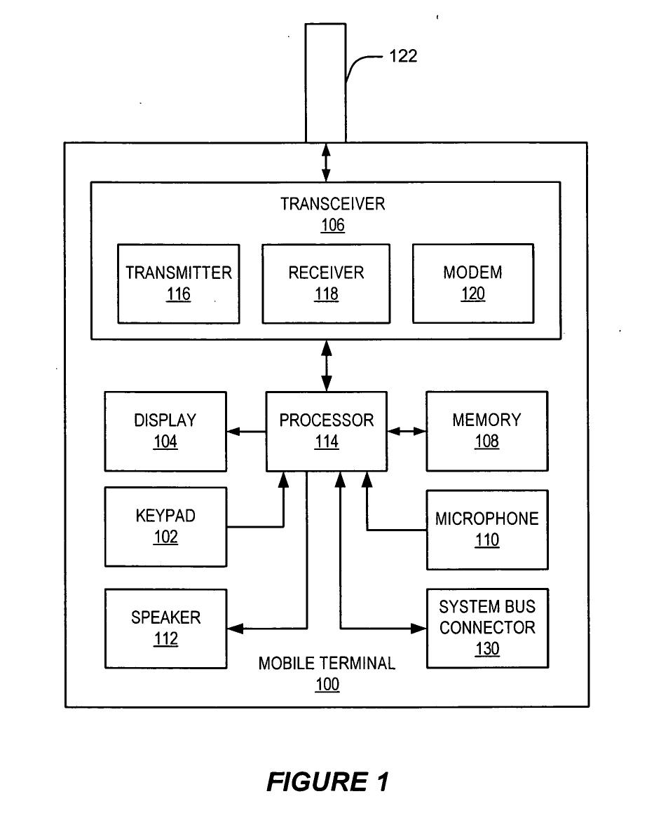

Embodiments of the present invention will now be described with reference to the schematic illustration of a personal electronic device, in particular, a wireless mobile terminal, in FIG. 1. Referring now to FIG. 1, an exemplary mobile terminal 100, in accordance with some embodiments of the present invention, includes a keypad 102, a display 104, a transceiver 106, a memory 108, a microphone 110, and a speaker 112 that communicate with a processor 114. The transceiver 106 typically includes a transmitter circuit 116, a receiver circuit 118, and a modem 120, which cooperate to transmit and receive radio frequency signals to remote transceivers via an antenna 122. The radio frequency signals transmitted between the mobile terminal 100 and the remote transceivers may comprise both traffic and control signals (e.g., paging signals/messages for incoming calls), which are used to establish and maintain communication with another party or destination.

The processor 114 is also coupled to a system bus connector 130, to which accessory devices may be attached. The accessory devices may communicate with the processor 114 through the system bus connector 130. In particular, the system bus connector 130 may provide conductors that permit the processor 114 to transmit/receive analog and/or digital audio and/or video signals, as well as data and/or control signals, to connected accessories. The system bus connector 130 may also provide power and/or ground connections for accessories attached thereto.

The memory 108 may be a general purpose memory that is used to store both program instructions for the processor 114 as well as data, such as audio data, video data, configuration data, and/or other data that may be accessed and/or used by the processor 114. The memory 108 may include a nonvolatile read/write memory, a read-only memory and/or a volatile read/write memory. In particular, the memory 108 may include a read-only memory in which basic operating system instructions are stored, a non-volatile read/write memory in which re-usable data, such as configuration information, directory information, and other information may be stored, as well as a volatile read/write memory, in which short-term instructions and/or temporary data may be stored.

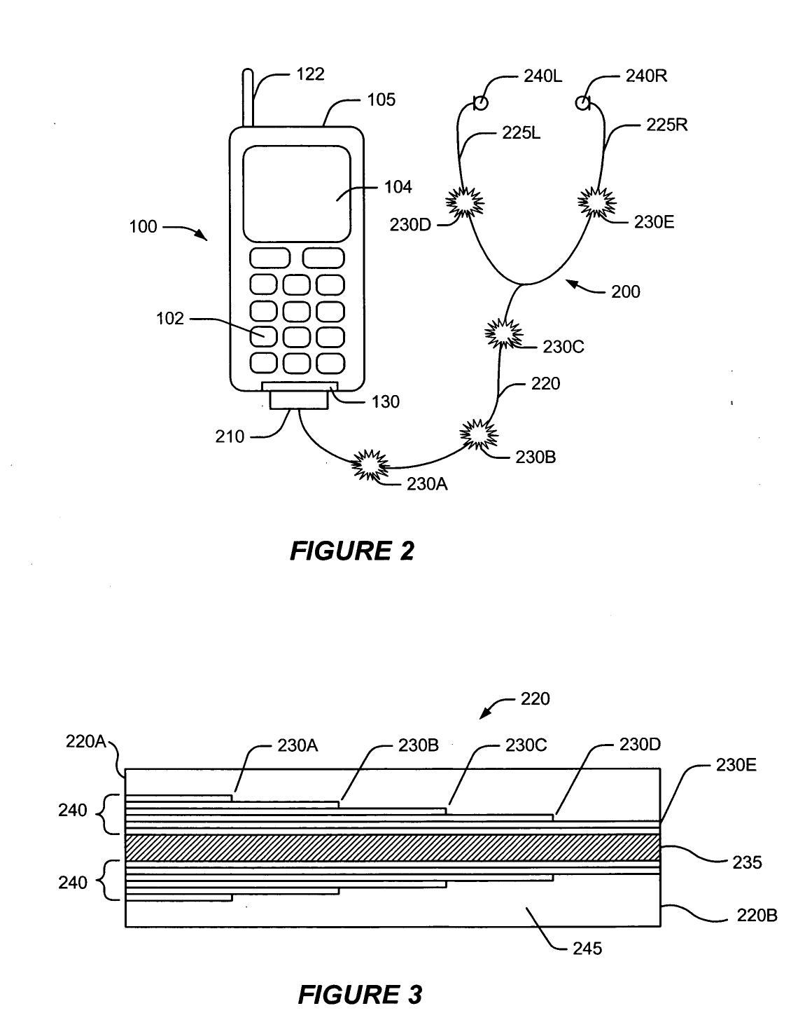

FIG. 2 is a schematic illustration of a mobile terminal 100 including an accessory 200 according to some embodiments of the invention. As illustrated therein, the mobile terminal 100 includes a housing 105 on which a keypad 102 is located. A display screen 104 may be used to provide graphical information to a user of the mobile terminal 100.

The accessory 200 illustrated in FIG. 2 is an earphone/cable combination that may be plugged into a system bus connector 130 of the mobile terminal 100. The accessory 200 includes an interface adapter 210, to which an earphone cable 220 is connected. A pair of left and right earphones 240L, 240R are connected at a distal end of the earphone cable 220 (one to each of a pair of left and right earphone extensions 225L and 225R).

The earphone cable 220 generally includes three electrical conductors (not shown), including one for each of the left and right audio channel signals and one ground conductor. The left and right earphone cable extensions 225L, 225R may include only two conductors. For example, the left earphone cable extension 225L may include one conductor for the left channel signal and one for ground, while the right earphone cable extension 225R may include one conductor for the right channel signal and one for ground. In some embodiments, the earphone cable 220 may include only two conductors (one for signal and one for ground). However, three conductors may permit the user to listen to stereo audio, which may be preferred.

The earphone cable 220 may further include one or more light emission locations 230A-230E, at which light may be emitted. In some embodiments, the earphone cable 220 may include light emitting devices positioned at the light emission locations 230A-230E and controlled by conductors extending to the light emission locations 230A-230E. However, in other embodiments, the interface adapter 210 may include light emitting devices, and light generated by the light emitting devices in the interface adapter 210 may be transmitted to the light emission locations 230A-230E via light guides that extend along the earphone cable 220 and terminate at various locations along the cable 220 corresponding to the light emission locations 230A-230E. Although five light emission locations 230A-230E are illustrated in FIG. 2, it will be appreciated that other embodiments of the invention may have more than five or less than five light emission locations 230A-230E. In addition, the light emission locations 230A-230E may or may not be located on the left and right earphone cable extensions 225L, 225R.

In particular embodiments, the light guides may include optical fibers, which guide light using total internal reflection caused by a difference in index of refraction between a central region, or core, of the fibers and an outer region, or cladding, of the fibers.

The light emitting devices may include solid state light emitting devices, such as inorganic light emitting diodes and/or laser diodes, and/or may include organic light emitting devices. Inorganic solid state lighting devices may be particularly applicable, as they may efficiently generate a high luminous output in a variety of colors, and may be designed with appropriate lenses and/or reflectors to emit light in a highly directional manner that may be easily coupled into an optical light guide, such as an optical fiber.

As discussed above, the interface adapter 210 may be connected to the system bus connector 130 of the mobile terminal 100. The processor 114 may be configured to provide outputs to the system bus connector 130 that control the illumination of the light emitting devices in the interface adapter 210 and/or the earphone cable 220, and thereby control the emission of light at the light emission regions 230A-230E.

An exemplary portion of an earphone cable 220 according to some embodiments of the invention is illustrated in FIG. 3. For illustration purposes, some elements of the earphone cable 220 shown in FIG. 3 have greatly exaggerated dimensions. As shown in FIG. 3, an earphone cable 220 according to some embodiments of the invention includes an audio cable 235, which may include insulated electrical conductors for the left channel signal, the right channel signal and ground, as discussed above. In addition, the earphone cable 220 includes a plurality of light guides 240, which in some embodiments may be optical fibers. The light guides 240 extend from a first end 220A of the earphone cable 220 toward a distal second end 220B of the earphone cable 220 and terminate at various light emission locations 230A-230E along the length of the earphone cable 220. Light is emitted at the light emission locations 230A-230E where the light guides 240 terminate along the length of the earphone cable 220. A flexible protective cover 245 surrounds the audio cable 235 and the light guides 240 and provides mechanical protection and support for the assembly. The flexible protective cover may be transparent, at least in regions surrounding the light emission locations 230A-230E. The flexible protective cover 245 may include, for example, a transparent polymer material.

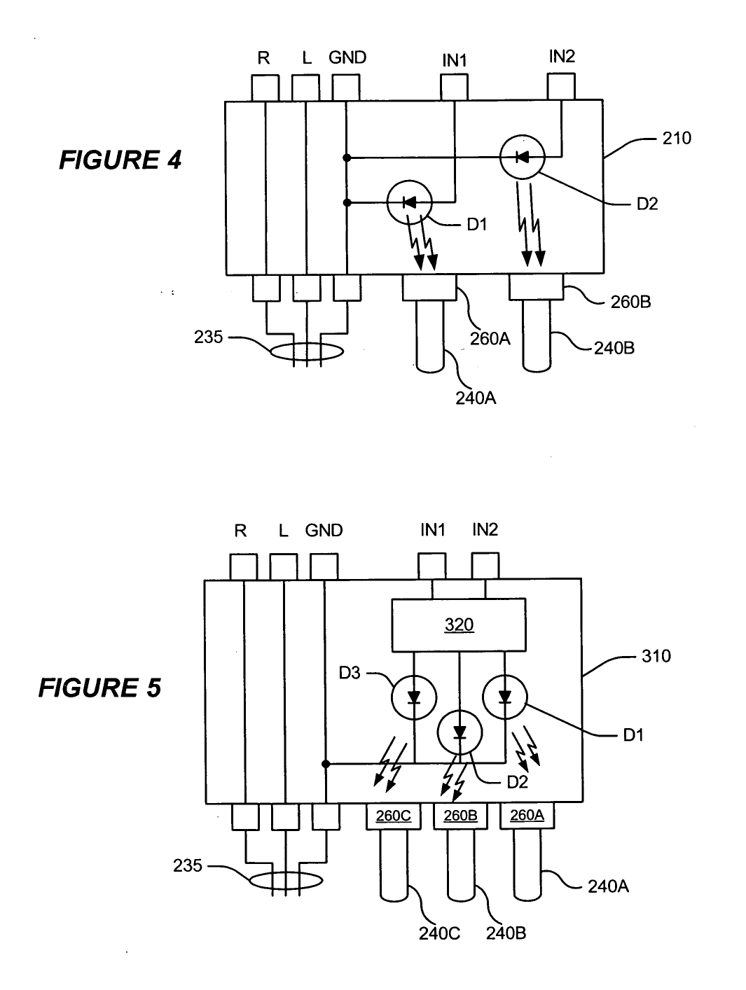

Referring now to FIG. 4, an interface adapter 210 according to some embodiments of the invention is illustrated therein. The interface adapter 210 includes a plurality of input connections including input connections for receiving a right channel signal (R), a left channel signal (L), and a ground connection (GND) from the system bus connector 130 of a mobile terminal 100. The right channel contact R is connected to a right channel conductor of the audio cable 235, which extends from the interface adapter 210. Similarly, the left channel contact L is connected to a left channel conductor of the audio cable 235, and the ground contact GND is connected to a ground conductor of the audio cable 235.

The interface adapter 210 also includes two input contacts IN1 and IN2 configured to receive control signals from the processor 114 through the system bus connector 130. The control signals received on the input contacts IN1 and IN2 control the operation of light emitting devices, such as light emitting diodes (LEDs) D1 and D2 in the interface adapter 210. As shown in FIG. 4, the first LED D1 includes an anode contact coupled to the input contact IN1, and the second LED D2 includes an anode contact coupled the input contact IN2. Both LEDs D1 and D2 include cathode contacts coupled to the ground contact GND. Thus, the state of the voltages applied to the input contacts IN1 and IN2 by the processor 114 controls the light output by the LEDs D1 and D2, respectively.

The interface adapter 210 may include other circuit elements, such as current limiting diodes, electrostatic discharge (ESD) protection diodes, and other elements. Furthermore, while two LEDs D1, D2 are shown in FIG. 4 for purposes of explanation, the interface adapter 210 may include less than two or more than two LEDs.

The LEDs D1, D2 may emit the same dominant wavelength (color) of light and/or may emit different dominant wavelengths (colors) of light. Light emitted by the LED D1 is received by an optical coupler 260A, which couples the light into at least one light guide 240A, which may include an optical fiber and/or a group of optical fibers within the earphone cable 220. Similarly, light emitted by the LED D2 is received by an optical coupler 260B, which couples the light into at least one light guide 240B, which may include an optical fiber and/or a group of optical fibers within the earphone cable 220. In some embodiments, light emitted by the LED D1 and the LED D2 may be coupled into the same optical couplers 260A, 260B.

The light guide 240A may include a number of optical fibers that terminate at the same location and/or different locations 230A-230E along the length of the earphone cable 220. Similarly, the light guide 240B may include a number of optical fibers that terminate at the same location and/or different locations 230A-230E along the length of the earphone cable 220. The optical fibers in the light guide 240A may terminate at the same and/or different locations as the optical fibers in the light guide 240B. Accordingly, depending on the number and color of LEDs D1, D2 provided in the interface adapter 210 and the configuration of the light guides 240A, 240B and light emitting locations 230A-230E along the length of the earphone cable 220, it may be possible to control the color, intensity and/or timing of light emitted at one or more of the light emission locations 230A-230E along the length of the earphone cable 220 by applying appropriate voltages to the input terminals IN1 and IN2. The intensity of light emitted at a particular light emission location 230A-230E may also depend on the number of optical fibers that terminate at that location.

In some embodiments, the processor 114 may cause light to be selectively emitted at the light emission locations 230A-230E in synchronization with beats of a music program played over the audio channels. In some embodiments, the processor 114 may cause light to be selectively emitted at the light emission locations 230A-230E in a predefined and/or random pattern upon the receipt of an incoming call. Furthermore, a user of the mobile terminal 100 may configure the mobile terminal 100 to cause the cable 220 to flash with a particular color/pattern upon receipt of a call from a particular caller.

In some embodiments, the processor 114 may be configured to cause light to be emitted at the light emission locations 230A-230E in a pattern that appears to move along the cable 220. For example, the processor 114 may cause the lights on the cable 220 to appear to be moving towards the earphones 240L, 240R and/or away from the earphones 240L, 240R, depending, for example, on whether the user is currently listening on the earphones 240L, 240R or talking into the microphone 110, by causing light to be emitted sequentially from the light emission locations 230A-230E. Moreover, different color lights may be emitted from the light emission locations 230A-230E depending on the state of the mobile terminal 100, for example, depending on whether the mobile terminal 100 is currently being used on a call, to listen to music, to watch video, or the like. As the light emission is controlled by the processor 114, the processor may turn the lights off to conserve battery power when the mobile terminal 100 is not in use and/or after a timeout period has elapsed. Many other possibilities exist within the scope of the present invention for controlling the light emission at the light emission locations 230A-230E.

An interface adapter 310 according to further embodiments of the invention is illustrated in FIG. 5. The interface adapter 310 includes a plurality of input connections including input connections for receiving a right channel signal (R), a left channel signal (L), and a ground connection (GND) from the system bus connector 130 of a mobile terminal 100. The right channel contact R is connected to a right channel conductor of the audio cable 235, which extends from the interface adapter 210. Similarly, the left channel contact L is connected to a left channel conductor of the audio cable 235, and the ground contact GND is connected to a ground conductor of the audio cable 235.

The interface adapter 310 also includes two inputs IN1 and IN2 configured to receive control signals from the processor 114 through the system bus connector 130. The input signals received on the inputs IN1 and IN2 control the operation of a decoder 320, which has outputs connected to three light emitting devices, such as light emitting diodes (LEDs) D1, D2 and D3. Current limiting resistors and/or constant current sources (not shown) may be connected in series with each of the LEDs D1-D3. In the embodiments illustrated in FIG. 5, the anodes of the LEDs D1-D3 are connected to respective outputs of the decoder 320, and the cathodes of the LEDs D1-D3 are commonly connected to the ground contact GND. Thus, the LEDs D1-D3 may be illuminated when their respective decoder outputs have a high voltage state. However, in other embodiments, the cathodes of the LEDs D1-D3 may be connected to outputs of the decoder 320 and the anodes of the LEDs D1-D3 may be commonly connected to a voltage source, in which case the LEDs may emit light when the respective outputs of the decoder 320 have a low voltage state.

The decoder 320 may be configured such that the state of the outputs of the decoder are controlled by the inputs applied at the input terminals IN1 and IN2 by the processor 114 of the mobile terminal 100. For example, the decoder 320 may be configured such that when an input of ‘00’ is applied to the inputs IN1 and IN2 (that is, an input signal of ‘0’ or LOW is applied to the input IN1 and an input signal of ‘0’ or LOW is applied to the input IN2), all of the outputs of the decoder are ‘0’ or LOW, resulting in no light output. The output lines to which the LEDs D1-D3 are connected may be individually addressed by applying an input of ‘01’, ‘10’ and/or ‘11’ to the inputs IN1, IN2, respectively. Thus, each of the three LEDs D1-D3 may be individually illuminated using only two input terminals IN1, IN2. In some embodiments, the LEDs D1-D3 may be sequentially activated by the processor 114 at a sufficient frequency to appear that the LEDs are being simultaneously illuminated.

Light emitted by the LED D1 is coupled to a light guide 240A through an optical coupler 260A. Similarly, light emitted by the LED D2 is coupled to a light guide 240B through an optical coupler 260B, and light emitted by the LED D3 is coupled to a light guide 240C through an optical coupler 260C. While three LEDs D1-D3 are illustrated in FIG. 5, embodiments of the invention may include more than three or less than three LEDs.

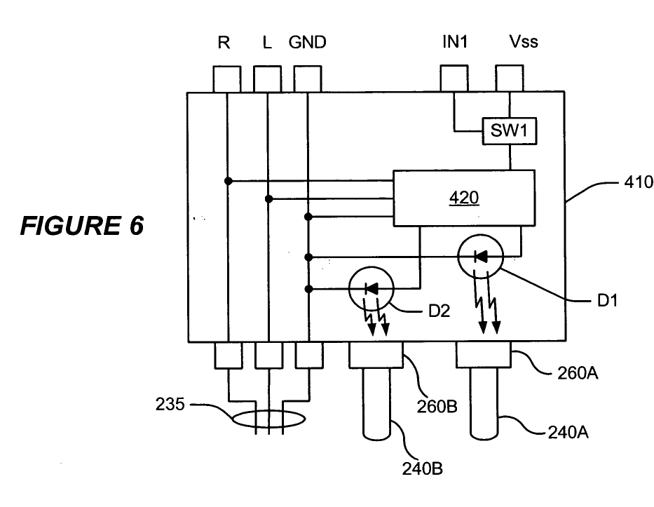

An interface adapter 410 according to further embodiments of the invention is illustrated in FIG. 6. The interface adapter 410 includes a plurality of input connections including input connections for receiving a right channel signal (R), a left channel signal (L), and a ground connection (GND) from the system bus connector 130 of a mobile terminal 100. The right channel contact R is connected to a right channel conductor of the audio cable 235, which extends from the interface adapter 210. Similarly, the left channel contact L is connected to a left channel conductor of the audio cable 235, and the ground contact GND is connected to a ground conductor of the audio cable 235.

The interface adapter 410 also includes a control input IN1 configured to receive control signals from the processor 114 through the system bus connector 130, and a voltage source input Vss, which provides a supply voltage to the interface adapter 410. The control signal received on control input IN1 is used to control a switch SW1, which selectively applies the source voltage Vss to an interface circuit 420 in the interface adapter 410. Accordingly, the operation of the interface circuit 420 may be selectively enabled and/or disabled based on control signals provided by the processor 114 via the control input IN1.

The interface circuit 420 controls the operation of LEDs D1 and D2, which are coupled to the interface circuit 420. The interface circuit 420 may also receive the right channel R and left channel L of the audio cable 235 as inputs. Accordingly, in some embodiments, the interface circuit 420 may cause the LEDs D1, D2 to be illuminated based on signals applied to the left and right channels of the audio cable 235. Light emitted by the LED D1 is coupled to a light guide 240A through an optical coupler 260A. Similarly, light emitted by the LED D2 is coupled to a light guide 240B through an optical coupler 260B. Thus, for example, light emitted at light emitting locations 230A-230E may appear to be controlled by and/or synchronized with audio programs (e.g. songs) played over the audio cable 235. While two LEDs D1-D2 are illustrated in FIG. 6, embodiments of the invention may include more than two or less than two LEDs.

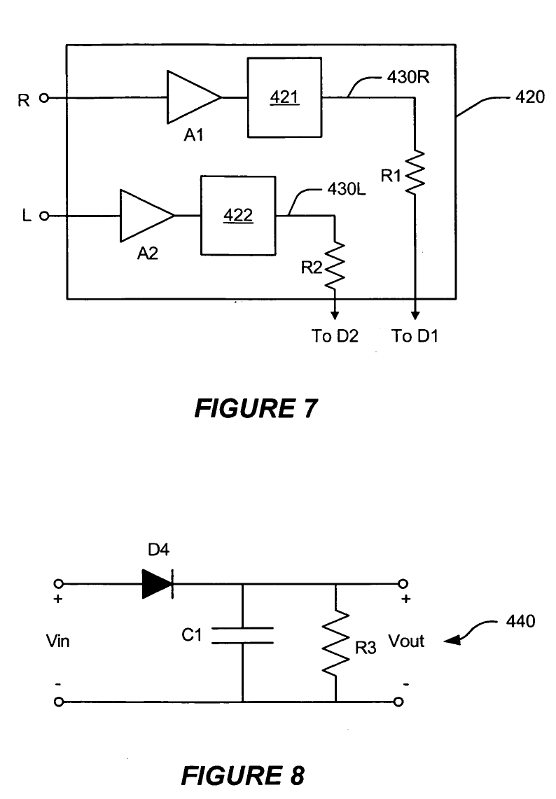

An interface circuit 420 according to some embodiments of the invention is illustrated in FIG. 7. As shown therein, the interface circuit 420 may include a right channel path 430R and a left channel path 430L. The right channel path 430R includes a right channel input R, a filter 421, an amplifier A1 and a current limiting resistor R1. The left channel path 430L includes a left channel input L, a filter 422, an amplifier A2 and a current limiting resistor R2. The filters 421, 422 may be low pass filters configured to pass only low frequency components of audio signals applied to the left and right channel inputs, L, R, respectively. The amplifiers A1, A2 are configured to amplify the filtered signals to a level sufficient to drive the operation of the LEDs D1, D2, and the current limiting resistors R1, R2 are provided to limit the current passing through the LEDs D1, D2 to a level that will not damage the LEDs. Thus, the LEDs may be illuminated by signals that appear to change in intensity in synchronization with audio signals on the left and right channels of the audio cable 235.

In some embodiments, the filters 421, 422 may be implemented as envelope detector circuits, as shown in FIG. 8. As illustrated therein, an envelope detector circuit 440 includes a series input diode D4 and a capacitor C1 and resistor R3 in parallel across a pair of output terminals. The diode D4 rectifies the input signal, and the resistor-capacitor combination causes the output waveform to follow the envelope of the input signal. When the amplitude of the input signal increases, the capacitor C1 charges, causing the output voltage level to increase, and when the amplitude of the input signal falls, the capacitor C1 discharges, causing the output voltage level to decrease. Thus, the LEDs D1, D2 may be caused to switch on and off in synchronization with changes in amplitude in the signals on the left and/or right channels.

Many other types of circuits may be used in the interface circuit 420. For example, the interface circuit 420 could include a controller and/or other logic circuits configured to control the operation of the diodes D1, D2.

It will be appreciated that, while embodiments of the present invention are described with respect to an interface adapter and elements/circuits included in an interface adapter, the elements/circuits described above as being implemented in an interface adapter could instead be incorporated in an electronic device, such as a mobile terminal 100.

Furthermore, as mentioned above, the cable 220 may include a plurality of LEDs disposed at one or more light emission locations 230A-230E along the length thereof and connected to the interface adapter by electrical conductors. Operation of the LEDs may be controlled by control signals applied to the interface adapter by the processor 114.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. An accessory for an electronic device, comprising:
an cable having first and second ends and including at least one signal conductor extending from the first end to the second end; and
a plurality of light guides attached to the cable, the light guides having first ends proximate the first end of the cable and extending along a length of the cable, respective ones of the plurality of light guides terminating at second ends at different points along the length of the cable.

2. The accessory of claim 1, further comprising a transparent protective covering on the cable and the plurality of light guides.

3. The accessory of claim 1, wherein the cable includes at least one earphone at the second end thereof.

4. The accessory of claim 1, further comprising an interface adapter coupled to the cable and the plurality of light guides and comprising at least one light emitting device, wherein the light guides are configured to receive light emitted by the at least one light emitting device.

5. The accessory of claim 4, wherein the interface adapter comprises an input terminal coupled to an anode of the at least one light emitting device and a ground terminal coupled to a cathode of the at least one light emitting device.

6. The accessory of claim 4, wherein the interface adapter comprises:
a decoder having a plurality of input lines and a plurality of output lines, and
a plurality of light emitting devices, wherein at least one of the plurality of light emitting devices is coupled to a respective one of the plurality of output lines and configured to be illuminated upon selection of the respective one of the plurality of output lines.

7. The accessory of claim 4, wherein the interface adapter comprises:
an audio input configured to receive an audio signal; and
an interface circuit coupled between the audio input and the at least one light emitting device and configured to control the illumination of the light emitting device based on the audio signal.

8. The accessory of claim 7, wherein the interface circuit comprises a filter configured to filter the audio signal.

9. The accessory of claim 8, wherein the filter comprises an envelope detector circuit.

10. The accessory of claim 7, wherein the interface circuit comprises an amplifier configured to amplify the audio signal.

11. The accessory of claim 7, further comprising:
a voltage source input configured to provide a voltage to the interface circuit, and
a switch configured to switch the voltage source input to the interface circuit in response to a control signal.

12. The accessory of claim 4, wherein the at least one light emitting device comprises a first light emitting device configured to emit light having a first dominant wavelength and wherein the plurality of light guides comprises a first plurality of light guides, the interface adapter further comprising:
a second light emitting device configured to emit light having a second dominant wavelength, different from the first dominant wavelength; and
a second plurality of light guides having first ends proximate the first end of the cable and extending along a length of the cable, respective ones of the second plurality of light guides terminating at second ends at different points along the length of the cable.

13. The accessory of claim 12, wherein respective ones of the second plurality of light guides terminate at different points along the length of the cable than the first plurality of light guides.

14. An accessory for an electronic device, comprising:
an interface adapter having a plurality of input terminals and configured to be attached to the electronic device;
a cable having a first end coupled to the interface adapter and a second end distal from the interface adapter; and
a plurality of light emission locations at different points along a length of the cable and configured to emit light in response to a control signal received by the interface adapter.

15. The accessory of claim 14, wherein the interface adapter includes at least one control input configured to receive the control signal.

16. The accessory of claim 14, wherein the interface adapter comprises at least one light emitting device and wherein the cable includes a plurality of light guides configured to receive light emitted by the at least one light emitting device and that extend from the interface adapter to respective ones of the light emission locations.

17. The accessory of claim 14, wherein the interface adapter comprises an input terminal coupled to an anode of the at least one light emitting device and configured to receive the control signal and a ground terminal coupled to a cathode of the at least one light emitting device.

18. The accessory of claim 14, wherein the interface adapter comprises:
a decoder having a plurality of input lines and a plurality of output lines, and
a plurality of light emitting devices, wherein at least one of the plurality of light emitting devices is coupled to a respective one of the plurality of output lines and is configured to be illuminated upon selection of the respective one of the plurality of output lines;
and wherein the cable includes a plurality of light guides configured to receive light emitted by the plurality of light emitting device and that extend from the interface adapter to respective ones of the light emission locations.

19. The accessory of claim 14, wherein the interface adapter comprises:
an audio input configured to receive an audio signal; and
an interface circuit coupled to the audio input and configured to control the emission of light at the light emission locations based on the audio signal.

20. The accessory of claim 19, wherein the interface circuit comprises a filter configured to filter the audio signal.

21. The accessory of claim 20, wherein the filter comprises an envelope detector circuit.

22. The accessory of claim 19, wherein the interface circuit comprises an amplifier configured to amplify the audio signal.

23. The accessory of claim 19, further comprising:
a voltage source input configured to provide a voltage to the interface circuit, and
a switch configured to switch the voltage source input to the interface circuit in response to a control signal.

24. A method of operating an accessory for an electronic device, the accessory comprising a cable including a plurality of light emission locations along a length thereof and configured to emit light in response to a control signal received by the accessory, the method comprising:
selectively illuminating the light emission locations in response to the control signal.

25. The method of claim 24, wherein selectively illuminating the light emission locations comprises selectively illuminating the light emission locations in response to an audio signal transmitted on the cable.

26. The method of claim 24, wherein the electronic device comprises a mobile telephone, and wherein selectively illuminating the light emission locations comprises selectively illuminating the light emission locations according to a selected pattern when a call is received at the mobile telephone.

27. The method of claim 26, wherein the selected pattern is based on a caller identification associated with the received call.

28. The method of claim 24, wherein selectively illuminating the light emission locations comprises selectively illuminating the light emission locations in synchronization with beats of an audio program transmitted on the cable.

29. The method of claim 24, wherein selectively illuminating the light emission locations comprises selectively illuminating the light emission locations in a pattern that appears to move along the cable toward and/or away from the electronic device.

30. The method of claim 24, wherein selectively illuminating the light emission locations comprises selectively illuminating the light emission locations based on a current state of the electronic device.
